(19) United States
(12) Patent Application Publication
(10) Pub. No.: US 2012/0118635 A1
(43) Pub. Date: May 17, 2012

(54) CONNECTION TERMINAL AND CIRCUIT COMPONENT

(75) Inventors: Junji TSURUOKA, Anjo-shi (JP); Seiji YASUI, Nagoya-shi (JP)

(73) Assignee: AISIN AW CO., LTD., Anjo-shi (JP)

(21) Appl. No.: 13/282,764

(22) Filed: Oct. 27, 2011

(30) Foreign Application Priority Data
Nov. 15, 2010 (JP) 2010-254967

(51) Int. Cl. H01R 4/02

(52) U.S. Cl. 174/84 R

(57) ABSTRACT

A conductive connection terminal having a planar joining surface joined to a joining target surface by a soldering material interposed between the joining surface and the joining target surface. The conductive connection terminal is configured such that, on either side across a predetermined reference straight line which, as well as passing through a center of gravity of the joining surface, extends along the joining surface, the joining surface includes indented portions indented from outer edge portions of the joining surface toward the reference straight line side.

### INCORPORATION BY REFERENCE

The disclosure of Japanese Patent Application No. 2010-254967 filed on Nov. 15, 2010, including the specification, drawings and abstract thereof, is incorporated herein by reference in its entirety.

### BACKGROUND OF THE INVENTION

1. Field of the Invention

The present invention relates to a conductive connection terminal having a planar joining surface joined to a joining target surface with a soldering material interposed between the joining surface and the joining target surface, and to a circuit component including the connection terminal.

2. Description of the Related Art

As a heretofore known technology relating to the heretofore described kind of connection terminal, there is a technology described in, for example, JP-A-2010-103222. Hereafter, the reference numerals and characters of JP-A-2010-103222 will be cited in the description of this background art. FIG. 1 of JP-A-2010-103222 shows a connection terminal (a terminal base 62a, 62b) including a planar joining surface joined to a joining target surface (the upper surface of an insulating substrate 20). The connection terminal includes three portions, specifically, a joining portion including a surface joined to the insulating substrate 20, an upper portion provided above the joining portion, and a linking portion linking the joining portion and upper portion.

Meanwhile, as described in Paragraph 0031 of JP-A-2010-103222 too, there is a case in which the connection terminal is joined to the joining target surface with solder (an example of a soldering material). Then, when the connection terminal is joined to the joining target surface with a soldering material, it is desirable that, as well as a soldering material melted by heating spreading all over the joining surface, no excess soldering material concentrates in one portion. This is because there is fear that the reliability of joining the connection terminal and joining target surface decreases due to the connection terminal being inclined, or the like, when the soldering material does not spread all over the joining surface, or when the excess soldering material concentrates in one portion.

In response to the heretofore described problem, there is known a technology of achieving a supply of the soldering material to the whole of the joining surface and a suppression of a local concentration of the excess soldering material by executing a process (a scrub process) of causing the connection terminal to oscillate in a plane parallel to the joining target surface in a condition in which the soldering material is melted. In order to execute the scrub process, it is necessary to provide an oscillation space for the oscillation in a joining region to which the connection terminal is joined. Then, in order to suppress an increase in size of a circuit component including the connection terminal, it is desirable that the oscillation space is provided so as to be as small as possible.

However, JP-A-2010-103222 has no description referring to the scrub process. Also, although a technology wherein a through hole is formed in a joining portion in order to increase the reliability of soldering (an example of brazing and soldering) is described in JP-A-2005-228898, JP-A-2005-228898 has no description referring to the scrub process either. For this reason, naturally, nothing concerning a configuration of the connection terminal preferred from the point of view of suppressing the oscillation space being shown in JP-A-2010-103222 or JP-A-2005-228898, this kind of configuration has not been ascertained yet.

### SUMMARY OF THE INVENTION

Therefore, there is a demand to realize a connection terminal having a preferred configuration from the point of view of suppressing an oscillation space necessary when executing a scrub process.

A characteristic configuration of a conductive connection terminal according to the invention having a planar joining surface joined to a joining target surface with a soldering material interposed between the joining surface and the joining target surface lies in a point that, on either side across a predetermined reference straight line which, as well as passing through a center of gravity of the joining surface, extends along the joining surface, the joining surface includes indented portions indented from outer edge portions of the joining surface toward the reference straight line side.

According to this characteristic configuration, it is possible, regardless of the shape of the joining surface, to form outer edges of the joining surface not only on either side in a direction parallel to the reference straight line (hereafter, referred to as a “reference direction”), but also on either side across the reference straight line, in such a way that the outer edges have portions intersecting the reference direction. Therefore, when executing a scrub process, simply by causing the connection terminal to oscillate in the reference direction, it is possible, on both sides across the reference straight line in addition to both sides in the reference direction, to appropriately push out a soldering material with the outer edge portions of the joining surface. Because of this, it is possible to achieve a supply of the soldering material to the whole of the joining surface and a suppression of a local concentration of an excess soldering material.

As heretofore described, according to the heretofore described characteristic configuration, when executing the scrub process in order to appropriately ensure the reliability of joining the connection terminal and joining target surface, the connection terminal is simply caused to oscillate in the reference direction, that is, caused to oscillate in one direction. That is, the oscillation space necessary for executing the scrub process is simply provided on outer sides of the joining surface in the reference direction, and it is possible to keep the oscillation space down, and suppress an increase in size of a circuit component including the connection terminal.

Herein, it is preferable that the connection terminal includes a plate-like joining portion including the joining surface on the lower surface and an extension portion provided in such a way as to extend upward from a region sandwiched between the adjacent indented portions in the outer edge portions of the joining portion.

In this application, regarding the shape of a member, to “extend” in a direction is used as a concept including not only a shape wherein, with the direction as a reference direction, an extension direction of the member is parallel to the reference direction, but also a shape wherein, even though the extension direction of the member is a direction intersecting the reference direction, the angle at which they intersect each other is less than 90 degrees.

According to this configuration, as the indented portions are formed in positions in the joining surface outer edge portions in which the extension portion is not provided, it is possible to achieve a simplification of a manufacturing process of the connection terminal. Also, with the heretofore described kind of configuration, the connection terminal becomes likely to be inclined depending on the shape of the extension portion, but it is possible to suppress the inclination of the connection terminal by executing the scrub process.

Also, it is preferable that the indented portion provided on one side of the reference straight line and the indented portion provided on the other side of the reference straight line are formed in shapes mutually symmetrical with respect to the reference straight line.

According to this configuration, when executing the scrub process by causing the connection terminal to oscillate in the reference direction, it is possible to push out the soldering material equally on both sides across the reference straight line. Therefore, when executing the scrub process, it is possible to prevent the soldering material becoming uneven on both sides of the reference straight line, and more reliably ensure the reliability of joining the connection terminal and joining target surface.

Also, it is preferable that the indented portions are formed in such a way that a width thereof in a direction parallel to the reference straight line increases as it goes from the reference straight line side toward the outer edge portion sides of the joining surface.

According to this configuration, when executing the scrub process by causing the connection terminal to oscillate in the reference direction, it is possible to more reliably push out the soldering material along with the oscillation of the indented portions. Also, by appropriately setting the width of the indented portions in the reference direction, it is possible to suppress a formation of a fillet on either side of the reference straight line, and keep down the size of a clearance provided on an outer side of the joining region in a direction perpendicular to the reference direction.

Also, it is preferable that a plated layer wettable with the soldering material is formed on the surfaces of the indented portions.

According to this configuration, when executing the scrub process by causing the connection terminal to oscillate in the reference direction, it is possible to more reliably push out the soldering material along with the oscillation of the indented portions.

A characteristic configuration of a circuit component according to the invention includes the connection terminal with the heretofore described kind of configuration, and a substrate having an element disposition surface as the joining target surface on which circuit elements are disposed, wherein the connection terminal is joined inside a joining region set on the element disposition surface, and the joining region has marginal regions, in which the circuit elements and joining surface are not disposed, on outer sides of the joining surface in a reference direction which is a direction parallel to the reference straight line.

According to this characteristic configuration, even when the connection terminal is joined to the substrate on which the circuit elements are disposed, it is possible to cause the connection terminal to oscillate in the reference direction by utilizing the marginal regions, meaning that it is possible to appropriately join the connection terminal with each heretofore described configuration to the element disposition surface using the scrub process.

### BRIEF DESCRIPTION OF THE DRAWINGS

FIG. 1 is a perspective view of a circuit component according to an embodiment of the invention;

FIG. 2 is a diagram showing each region formed on an element disposition surface according to the embodiment of the invention;

FIG. 3 is a bottom view of a connection terminal according to the embodiment of the invention; and

FIG. 4 is an enlarged view of a vicinity of a joining portion of a first connection terminal and substrate according to the embodiment of the invention.

### DETAILED DESCRIPTION OF THE EMBODIMENTS

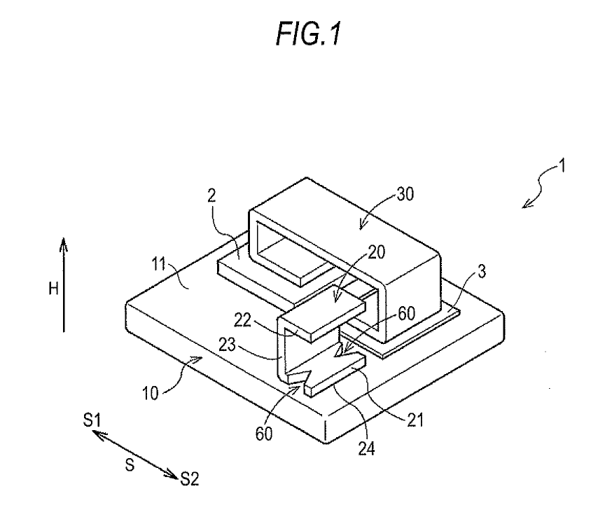

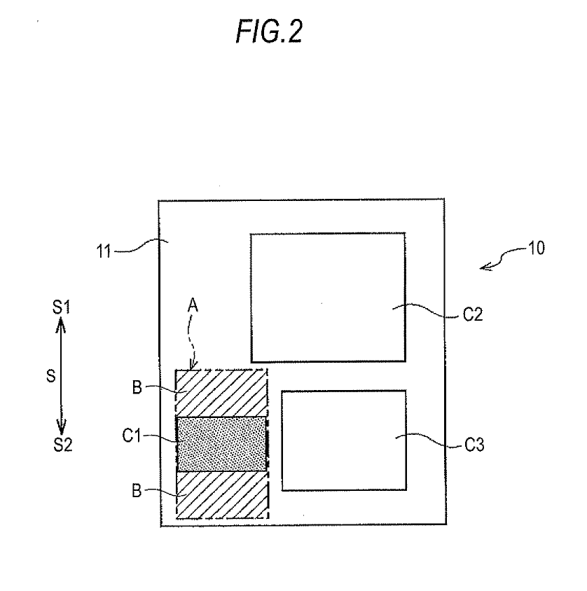

A description will be given, referring to the drawings, of an embodiment of a connection terminal and circuit component according to the invention. Herein, a case in which the connection terminal according to the invention is applied to a connection terminal used in a semiconductor device (an example of an electric circuit device) including a semiconductor element (an example of a circuit element), and the circuit component according to the invention is a semiconductor device circuit component including the connection terminal, the semiconductor element, and a substrate, will be described as an example. As shown in FIG. 1, in a circuit component 1 according to the embodiment, a first connection terminal 20 for connecting circuit elements (a switching element 2 and a diode element 3) disposed on an element disposition surface 11 of a substrate 10 and a connection member (not shown) is joined inside a joining region A (refer to FIG. 2) formed on the element disposition surface 11. With this kind of configuration, the circuit component 1 according to the embodiment has characteristics in the configuration of the first connection terminal 20 and the configuration of the joining region A for disposing the first connection terminal 20. Hereafter, a description will be given in the order of an “overall configuration of the circuit component” and a “configuration of the first connection terminal”.

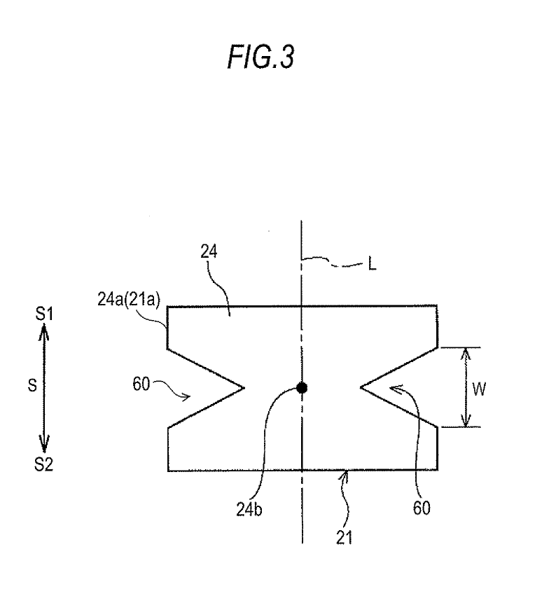

In the following description, “up” indicates a direction (a +H direction, the upward direction in FIG. 1) in which the height increases in a height direction H (a direction perpendicular to a joining surface 24), and “down” indicates a direction (a −H direction, the downward direction in FIG. 1) in which the height decreases in the height direction H. Also, as shown in FIG. 3, a predetermined straight line which, as well as passing through a center of gravity 24b of the joining surface 24, extends along the joining surface 24, is taken to be a reference straight line L, and a direction parallel to the reference straight line L is taken to be a reference direction S. Then, a “reference first direction S1” indicates an upper left of FIG. 1 in the reference direction 5, and a “reference second direction S2” indicates a lower right of FIG. 1 in the reference direction S.

### 1. Overall Configuration of Circuit Component

A description will be given, referring to FIG. 1, of the overall configuration of the circuit component. As shown in FIG. 1, the circuit component 1 includes the switching element 2, the diode element 3, the first connection terminal 20, a second connection terminal 30, and the substrate 10. The upper surface of the substrate 10 is made the element disposition surface 11 for disposing the switching element 2 and diode element 3. In this example, the substrate 10 is formed from a conductive material (for example, a metallic material such as copper or aluminum), and the substrate 10 also functions as a heat spreader.

The switching element 2 and diode element 3 are disposed as the circuit elements on the element disposition surface 11. In this example, the switching element 2 and diode element 3 are disposed aligned in the reference direction S. That is, the alignment direction of the circuit elements (in this example, the switching element 2 and diode element 3) on the element disposition surface 11 coincides with the reference direction S. The switching element 2 includes an emitter electrode on the upper surface, and includes a collector electrode on the lower surface. Then, the switching element 2 is fixed to the element disposition surface 11 with solder, and the collector electrode on the lower surface has continuity with the substrate 10. Also, the diode element 3 includes an anode on the upper surface, and includes a cathode on the lower surface. Then, the diode element 3 is fixed to the element disposition surface 11 with solder, and the cathode on the lower surface has continuity with the substrate 10. That is, the substrate 10 is of the same potential as the collector electrode of the switching element 2 and the cathode of the diode element 3. In the embodiment, both the switching element 2 and diode element 3 correspond to “circuit elements” in the invention. That is, in the embodiment, the circuit elements are taken to be the semiconductor elements (electronic elements).

The circuit component 1 according to the embodiment is taken to be a circuit component configuring a semiconductor device (not shown) including an inverter circuit for controlling a rotating electrical machine (not shown). The semiconductor device includes a plurality (in this example, six) of the circuit components 1 shown in FIG. 1, and a bridge circuit configuring the inverter circuit is formed of a total of six switching elements 2 included in the six circuit components 1. The switching elements 2, and the rotating electrical machine and a power supply (not shown), are electrically connected via the connection member (not shown) such as a bus bar. Each of the six diode elements 3, being connected in parallel between the emitter and collector of the switching element 2, functions as a FWD (Free Wheel Diode). Also, the rotating electrical machine which is en object controlled by the semiconductor device is taken to be a three phase alternating current motor (motor generator) included as a drive power source in, for example, an electric vehicle or a hybrid vehicle.

In order to electrically connect the switching element 2 and diode element 3 and the connection member, the first connection terminal 20 and second connection terminal 30 are included in the circuit component 1. Both the first connection terminal 20 and second connection terminal 30, being formed from a conductive material (for example, a metallic material such as copper or aluminum), in this example, are made by bending and forming a belt-like member (a plate-like member) of a certain width.

The first connection terminal 20 is fixed with solder to the element disposition surface 11 included in the substrate 10. Then, the first connection terminal 20 has continuity with the lower surface (collector electrode) of the switching element and the lower surface (cathode) of the diode element 3 via the substrate 10 formed from a conductive material. Also, the upper surface of the first connection terminal 20 forms a joining surface joined (for example, joined by laser welding) to the connection member. Then, in the embodiment, it is taken that a scrub process has been executed on the first connection terminal 20 at the time of the joining thereof to the element disposition surface 11 with solder. A detailed configuration of the first connection terminal 20 will be described later in the second chapter. In the embodiment, the first connection terminal 20 corresponds to a “connection terminal” in the invention. In the embodiment, the element disposition surface 11 corresponds to a “joining target surface” in the invention.

The second connection terminal 30 is fixed to the upper surfaces of the semiconductor elements (the switching element 2 and diode element 3) with solder. That is, in this example, the second connection terminal 30 is disposed on the substrate 10 across the semiconductor elements (circuit elements) in between. As shown in FIG. 1, the second connection terminal 30 is disposed in a condition in which it electrically connects the upper surface (emitter electrode) of the switching element 2 and the upper surface (anode) of the diode element 3. Then, the upper surface of the second connection terminal 30 forms a joining surface joined (for example, joined by laser welding) to the connection member.

### 2. Configuration of First Connection Terminal

Next, a detailed description will be given of the configuration of the first connection terminal 20. The first connection terminal 20, as shown in FIG. 1, includes a first joining portion 21, a second joining portion 22, and a linking portion 23 which links the first joining portion 21 and second joining portion 22. As heretofore described, in this example, the first connection terminal 20 is made by bending and forming a belt-like member (a plate-like member) of a certain width. Therefore, each portion (the first joining portion 21, second joining portion 22, and linking portion 23) of the first connection terminal 20 is formed into a plate.

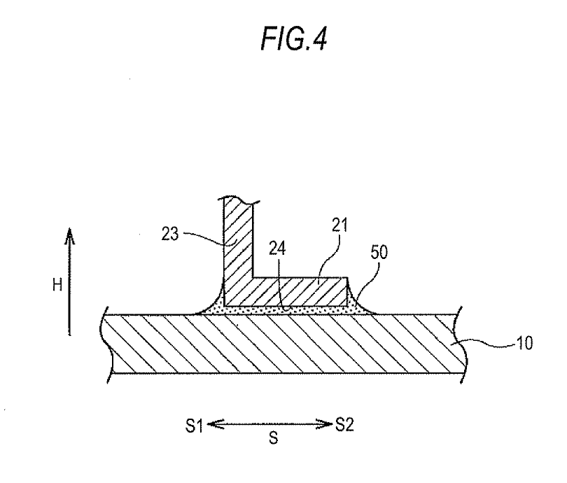

The first joining portion 21 is a portion joined to the element disposition surface 11, and the lower surface of the first joining portion 21 is made the planar joining surface 24 joined to the element disposition surface 11. In this example, the joining surface 24 and element disposition surface 11 are joined with solder 50, as shown in FIG. 4. That is, the first connection terminal 20 has the joining surface 24 joined to the element disposition surface 11 with the solder 50 interposed between the joining surface 24 and the element disposition surface 11. As the joining surface 24 is disposed parallel to the element disposition surface 11, the height direction H which is the direction perpendicular to the joining surface 24 is also a direction perpendicular to the element disposition surface 11. In the embodiment, the first joining portion 21 corresponds to a “joining portion” in the invention. Also, in the embodiment, the solder 50 corresponds to a “soldering material” in the invention. In the invention, it is possible to employ various kinds of solder regardless of the kind of metal (for example, tin) contained as a principal component.

The second joining portion 22 is a portion whose surface joined to the connection member is formed on the top. The second joining portion 22 is spaced away from the first joining portion 21 in the height direction H and, in this example, the first joining portion 21 and second joining portion 22 are disposed parallel to each other. Also, in the embodiment, the first joining portion 21 and second joining portion 22, as well as being formed so as to have rectangular shapes of sizes the same as each other, are disposed in such a way as to be superimposed one on the other as viewed in the height direction H. More specifically, in the embodiment, the first joining portion 21 and second joining portion 22 are disposed in such a way that one of them is hidden behind the other, except portions which can be seen through indented portions 60, to be described hereafter, when viewed from either side in the height direction H. It is also possible to adopt a configuration wherein the first joining portion 21 and second joining portion 22 are formed to have rectangular shapes of sizes differing from one another.

The linking portion 23, in this example, links end portions of the first joining portion 21 and second joining portion 22 in the reference direction S. Furthermore, in this example, the linking portion 23 links end portions of the first joining portion 21 and second joining portion 22 on sides the same as each other in the reference direction S (in the example shown in FIG. 1, the reference first direction S1 side end portions). Then, in the embodiment, the first joining portion 21 and second joining portion 22 are formed so as to have rectangular shapes of sizes the same as each other, as heretofore described, and the linking portion 23 is formed so as to extend in the height direction H. Because of this, the shape of the first connection terminal 20 sectioned by a plane including both the height direction H and reference direction S is formed in a square U-shape. In the embodiment, the linking portion 23 corresponds to an “extension portion” according to the invention.

Then, as shown in FIGS. 1 and 3, the joining surface 24 includes the indented portions 60, indented from outer edge portions 24a toward the reference straight line L side, on either side across the reference straight line L which, as well as passing through the center of gravity 24b of the joining surface 24, is the predetermined straight line along the joining surface 24. In this example, as the joining surface 24 is formed into a rectangle when excluding the indented portions 60, as shown in FIG. 3, the center of gravity 24b of the joining surface 24 is the point of intersection between the diagonal lines of the rectangle. The shape of the joining surface 24 can be made circular, polygonal, or the like, apart from rectangular.

By including such indented portions 60, as shown in FIG. 3, the outer edges of the joining surface 24 are formed not only on either side of the joining surface 24 in the reference direction S, but also on either side across the reference straight line L in such a way as to have portions intersecting the reference direction S. Therefore, when executing the scrub process when joining the first connection terminal 20 and element disposition surface 11, simply by causing the first connection terminal 20 to oscillate in the reference direction S, it is possible, on both sides across the reference straight line L in addition to both sides in the reference direction S, to appropriately push out the solder 50 with the outer edge portions 24a corresponding to the indented portions 60 of the joining surface 24. That is, it being sufficient that an oscillation space necessary for executing the scrub process is provided on at least outer sides of the joining surface 24 in the reference direction S, it is possible to keep the size of the oscillation space down and suppress an increase in size of the circuit component 1.

In this example, the joining surface 24 includes one indented portion 60 on either side across the reference straight line L, and includes two indented portions 60 in total. Then, the linking portion 23 is provided in such a way as to extend upward (in the +H direction) (in this example, in the height direction H) from a region of an outer edge portion 21a of the first joining portion 21 sandwiched between the adjacent indented portions 60.

In the embodiment, as shown in FIG. 3, the indented portions 60 are formed in such a way that a width W thereof in the direction (reference direction S) parallel to the reference straight line L increases as it goes from the reference straight line L side toward the outer edge portion 24a sides of the joining surface 24. Specifically, the indented portions 60 are taken to be notched portions of a triangular shape (a V-shape) in section. Herein, the section means a section taken along a plane perpendicular to the height direction H (a plane parallel to the joining surface 24). That is, the indented portions 60 have a shape wherein one portion of each outer edge portion 24a of the joining surface 24 is notched in a triangular shape (a V-shape) in a plan view (as viewed in the height direction H).

Also, in the embodiment, as shown in FIG. 3, the indented portions 60 are formed at the points of intersection between a straight line which, as well as passing through the center of gravity 24b of the joining surface 24, is perpendicular to the reference straight line L, and the outer edge portions 24a of the joining surface 24, as viewed in the height direction H. Then, in this example, each of the indented portions 60 is formed in a shape symmetrical with respect to the straight line perpendicular to the reference straight line L, as viewed in the height direction H. That is, in this example, the indented portions 60 are made notched portions of an isosceles triangular shape in section.

Furthermore, in the embodiment, as shown in FIG. 3, the indented portions 60 are formed in such a way that the indented portion 60 provided on one side of the reference straight line L and the indented portion 60 provided on the other side of the reference straight line L are of shapes mutually symmetrical with respect to the reference straight line L, as viewed in the height direction H. Because of this, when executing the scrub process when joining the first connection terminal 20 and element disposition surface 11, it is possible to push out the solder 50 equally on both sides across the reference straight line L, and prevent the solder 50 becoming uneven on both sides of the reference straight line L.

Then, the first connection terminal 20 having the heretofore described kind of configuration is joined inside the joining region A set on the element disposition surface 11. As shown in FIG. 2, in addition to the joining region A, a switching element disposition region C2, which is a region in which the switching element 2 is disposed, and a diode element disposition region C3, which is a region in which the diode element 3 is disposed, are set on the element disposition surface 11. Then, the joining region A is provided adjacent to the switching element disposition region C2 and diode element disposition region C3. Specifically, the joining region A is provided substantially adjacent to the disposition regions C2 and C3 of the circuit elements in a direction perpendicular to the alignment direction of the relevant circuit elements (in this example, to the reference direction S).

The joining region A has a joining surface disposition region C1, which is a region in which the joining surface 24 is disposed, and marginal regions B, which are regions positioned on outer sides (in this example, either outer side) of the joining surface disposition region C1 in the reference direction S. Herein, the marginal regions B mean regions in which the circuit elements (in this example, the switching element 2 and diode element 3) and the joining surface 24 are not disposed. That is, in this example, the joining region A has the marginal regions B, in which the circuit elements and the joining surface 24 are not disposed, on the outer sides (in this example, either outer side) of the joining surface 24 in the reference direction S.

The joining surface disposition region C1 is taken to be a region of a size the same as that of the joining surface 24. Also, a length of each marginal region B in a direction perpendicular to the reference direction S is taken to be equal to or greater than (in the example shown in FIG. 2, the same as) a length of the joining surface 24 in the relevant direction. Also, a length of each marginal region B in the reference direction S is preferably a half or more of the length of the joining surface 24 in the reference direction S, and more preferably, equal to or greater than the length of the joining surface 24 in the reference direction S. In the example shown in FIG. 2, the length of each marginal region B in the reference direction S is set to be slightly less than the length of the joining surface 24 in the reference direction S.

Herein, as heretofore described, when executing the scrub process when joining the first connection terminal 20 and element disposition surface 11, simply by oscillating the first connection terminal 20 in the reference direction S, it is possible, on both sides across the reference straight line L in addition to both sides in the reference direction S, to appropriately push out the solder 50 with the outer edge portions 24a corresponding to the indented portions 60 of the joining surface 24. That is, when executing the scrub process when joining the first connection terminal 20 and element disposition surface 11, it is possible to make an oscillation direction of the first connection terminal 20 only a direction parallel to the reference direction S. Therefore, as in this example, even with a configuration wherein the joining region A does not have a region of a size sufficient to cause the first connection terminal 20 to oscillate on outer sides of the joining surface 24 in the direction perpendicular to the reference direction S, by appropriately executing the scrub process utilizing the marginal regions B on the outer sides in the reference direction S, it is possible to supply solder to the whole of the joining surface 24 and prevent excess solder concentrating in one portion. In this way, according to the invention, it is possible to appropriately ensure the reliability of joining the first connection terminal 20 and element disposition surface 11, while keeping down the size of the oscillation space necessary for the scrub process and suppressing an increase in size of the circuit component 1.

Also, in the embodiment, a plated layer wettable with solder (solder wettable) is formed on the surfaces of the indented portions 60. The “surfaces of the indented portions 60” are used as a concept including surfaces extending in the +H direction (the upward height direction H) from portions of the outer edge portions 24a of the joining surface 24 corresponding to the indented portions 60. The plated layer is formed from a metal such as, for example, gold or nickel. Because of this, when executing the scrub process by causing the first connection terminal 20 to oscillate in the reference direction S, it is possible to reliably push out the solder 50 along with an oscillation of the indented portions 60. It is possible to adopt a configuration wherein a solder wettable plated layer is formed not only on the surfaces of the indented portions 60, but also on the surface of another portion of the first connection terminal 20 (for example, the lower surface of the first joining portion 21 or the upper surface of the second joining portion 22), or a configuration wherein a solder wettable plated layer is formed on the whole surface of the first connection terminal 20.

### 3. Other Embodiments

Finally, a description will be given of other embodiments according to the invention. A characteristic disclosed in each following embodiment can be utilized not only in the relevant embodiment, but also applied to another embodiment provided that no inconsistency occurs.

(1) In the heretofore described embodiment, the configuration wherein the indented portions 60 are the notched portions of the triangular shape (V-shape) in section has been described as an example. However, the embodiment of the invention not being limited to this, the indented portions 60 can also be made, for example, notched portions of a semicircular shape in section, or notched portions of a rectangular shape in section.

(2) In the heretofore described embodiment, the configuration wherein the first connection terminal 20 includes the joining portion (first joining portion 21) and the extension portion (linking portion 23) has been described as an example, but it is possible to employ any form as the form of the first connection terminal 20. For example, it is possible to adopt a configuration wherein the first connection terminal 20 is configured of only a joining portion, and the joining portion is formed in a columnar form or a prismatic form. In this case, it is possible to adopt a configuration wherein the indented portions 60 are formed in the whole region of the joining portion in the height direction H, or a configuration wherein the indented portions 60 are formed in only a lower side portion of the joining portion in the height direction H.

(3) In the heretofore described embodiment, the configuration wherein the joining region A has the marginal regions B on either outer side of the joining surface 24 in the reference direction S has been described as an example, but it is also possible to adopt a configuration wherein the joining region A has the marginal region B only on one side of the joining surface 24 in the reference direction S. In this case, it is preferable that the length of the marginal region B in the reference direction S is set to be equal to or greater than the length of the joining surface 24 in the reference direction S.

(4) In the heretofore described embodiment, the configuration wherein the indented portion 60 provided on one side of the reference straight line L and the indented portion 60 provided on the other side of the reference straight line L are formed in the shapes mutually symmetrical with respect to the reference straight line L has been described as an example, but it is also possible to adopt a configuration wherein they are formed in shapes asymmetrical with respect to the reference straight line L.

(5) In the heretofore described embodiment, the configuration wherein the indented portions 60 are formed in such a way that the width W thereof in the reference direction S increases as it goes from the reference straight line L side toward the outer edge portion 24a sides of the joining surface 24 has been described as an example. However, the embodiment of the invention not being limited to this, it is also possible to adopt a configuration wherein the width W of the indented portions 60 in the reference direction S is constant, or a configuration wherein the indented portions 60 are formed in such a way that the width W thereof in the reference direction S decreases as it goes from the reference straight line L side toward the outer edge portion 24a sides of the joining surface 24.

(6) In the heretofore described embodiment, the configuration wherein the solder wettable plated layer is formed on the surfaces of the indented portions 60 has been described as an example, but it is also possible to adopt a configuration wherein this kind of plated layer is not included depending on the material of the first connection terminal 20.

(7) In the heretofore described embodiment, the configuration wherein the joining surface 24 includes one indented portion 60 on either side across the reference straight line L has been described as an example. However, the embodiment of the invention not being limited to this, it is possible to adopt a configuration wherein the joining surface 24 includes N (N is an integer of two or more) indented portions 60 on each of both sides across the reference straight line L. Also, it is also possible to adopt a configuration wherein mutually differing numbers of indented portions 60 are formed on either side across the reference straight line L.

(8) In the heretofore described embodiment, the configuration wherein the end portions of the first joining portion 21 and second joining portion 22 on the same side in the reference direction S are linked together has been described as an example. However, the embodiment of the invention not being limited to this, it is also possible to adopt a configuration wherein end portions of the first joining portion 21 and second joining portion 22 on sides differing from one another in the reference direction S are linked together. With this kind of configuration, the linking portion 23 can be formed in such a way as to extend uniformly in a direction obliquely intersecting the height direction H, or it is also possible to adopt a configuration wherein the linking portion 23 has a single or a plurality (for example, two) of bent portions in an intermediate portion of the linking portion 23.

(9) In the heretofore described embodiment, the configuration wherein the first connection terminal 20 is joined to the element disposition surface 11 has been described as an example, but it is also possible to adopt a configuration wherein the first connection terminal 20 is joined to the upper surface of the circuit element (for example, the switching element 2 or the diode element 3) placed on the element disposition surface 11. That is, it is possible to adopt the surface (upper surface) of the circuit element as the joining target surface in place of the element disposition surface 11 of the substrate 10.

(10) In the heretofore described embodiment, the configuration wherein the soldering material in the invention is solder has been described as an example. However, the embodiment of the invention not being limited to this, it is possible to employ various kinds of soldering material (for example, one containing gold, silver, or copper. Whether it is hard solder or soft solder is no object.) provided that it has a melting point lower than the connection terminal (first connection terminal 20) and the joining target surface (element disposition surface 11). Furthermore, the soldering material not being limited to a material formed from an alloy, it is possible to employ, as the soldering material, any conductive material that can join the connection terminal and joining target surface by being liquefied by heating and solidified by cooling (including natural cooling).

(11) Regarding other configurations too, the embodiments disclosed in this specification are illustrative in every respect, and the embodiments of the invention are not limited to these. That is, as long as the embodiments include the configurations described in the claims of this application and configurations equivalent thereto, a configuration wherein one portion of configurations not described in the claims is appropriately altered is also by rights incorporated in the technical scope of the invention.

The invention can be suitably applied to a conductive connection terminal having a planar joining surface joined to a joining target surface by a soldering material interposed between the joining surface and the joining target surface.

What is claimed is:

1. A conductive connection terminal having a planar joining surface joined to a joining target surface by a soldering material interposed between the joining surface and the joining target surface, wherein
on either side across a predetermined reference straight line which, as well as passing through a center of gravity of the joining surface, extends along the joining surface, the joining surface includes indented portions indented from outer edge portions of the joining surface toward the reference straight line side.

2. The connection terminal according to claim 1, comprising: a plate-like joining portion including the joining surface on the lower surface; and an extension portion provided in such a way as to extend upward from a region sandwiched between the adjacent indented portions in the outer edge portions of the joining portion.

3. The connection terminal according to claim 2, wherein
the indented portion provided on one side of the reference straight line and the indented portion provided on the other side of the reference straight line are formed in shapes mutually symmetrical with respect to the reference straight line.

4. The connection terminal according to claim 3, wherein
the indented portions are formed in such a way that a width thereof in a direction parallel to the reference straight line increases as it goes from the reference straight line side toward the outer edge portion sides of the joining surface.

5. The connection terminal according to claim 4, wherein
a plated layer wettable with the soldering material is formed on the surfaces of the indented portions.

6. A circuit component comprising: the connection terminal according to claim 5; and a substrate having an element disposition surface as the joining target surface on which circuit elements are disposed, wherein
the connection terminal is joined inside a joining region set on the element disposition surface, and
the joining region has marginal regions, in which the circuit elements and joining surface are not disposed, on outer sides of the joining surface in a reference direction which is a direction parallel to the reference straight line.

7. The connection terminal according to claim 1, wherein
the indented portion provided on one side of the reference straight line and the indented portion provided on the other side of the reference straight line are formed in shapes mutually symmetrical with respect to the reference straight line.

8. The connection terminal according to claim 7, wherein
the indented portions are formed in such a way that a width thereof in a direction parallel to the reference straight line increases as it goes from the reference straight line side toward the outer edge portion sides of the joining surface.

9. The connection terminal according to claim 8, wherein
a plated layer wettable with the soldering material is formed on the surfaces of the indented portions.

10. A circuit component comprising: the connection terminal according to claim 9; and a substrate having an element disposition surface as the joining target surface on which circuit elements are disposed, wherein
the connection terminal is joined inside a joining region set on the element disposition surface, and
the joining region has marginal regions, in which the circuit elements and joining surface are not disposed, on outer sides of the joining surface in a reference direction which is a direction parallel to the reference straight line.

11. The connection terminal according to claim 1, wherein
the indented portions are formed in such a way that a width thereof in a direction parallel to the reference straight line increases as it goes from the reference straight line side toward the outer edge portion sides of the joining surface.

12. The connection terminal according to claims to 11, wherein
a plated layer wettable with the soldering material is formed on the surfaces of the indented portions.

13. A circuit component comprising: the connection terminal according to claim 12; and a substrate having an element disposition surface as the joining target surface on which circuit elements are disposed, wherein
the connection terminal is joined inside a joining region set on the element disposition surface, and
the joining region has marginal regions, in which the circuit elements and joining surface are not disposed, on outer sides of the joining surface in a reference direction which is a direction parallel to the reference straight line.

14. The connection terminal according to claim 1, wherein
a plated layer wettable with the soldering material is formed on the surfaces of the indented portions.

15. A circuit component comprising: the connection terminal according to claim 14; and a substrate having an element disposition surface as the joining target surface on which circuit elements are disposed, wherein
the connection terminal is joined inside a joining region set on the element disposition surface, and
the joining region has marginal regions, in which the circuit elements and joining surface are not disposed, on outer sides of the joining surface in a reference direction which is a direction parallel to the reference straight line.

16. A circuit component comprising: the connection terminal according to claim 1; and a substrate having an element disposition surface as the joining target surface on which circuit elements are disposed, wherein
the connection terminal is joined inside a joining region set on the element disposition surface, and
the joining region has marginal regions, in which the circuit elements and joining surface are not disposed, on outer sides of the joining surface in a reference direction which is a direction parallel to the reference straight line.

17. The connection terminal according to claim 2, wherein
the indented portions are formed in such a way that a width thereof in a direction parallel to the reference straight line increases as it goes from the reference straight line side toward the outer edge portion sides of the joining surface.

18. The connection terminal according to claim 17, wherein
a plated layer wettable with the soldering material is formed on the surfaces of the indented portions.

19. A circuit component comprising: the connection terminal according to claim 18; and a substrate having an element disposition surface as the joining target surface on which circuit elements are disposed, wherein
the connection terminal is joined inside a joining region set on the element disposition surface, and
the joining region has marginal regions, in which the circuit elements and joining surface are not disposed, on outer sides of the joining surface in a reference direction which is a direction parallel to the reference straight line.
